(19) United States
(12) Patent Application Publication
(10) Pub. No.: US 2026/0236461 A1
(43) Pub. Date: Aug. 13, 2026

(54) DISCOVERING AND MITIGATING ROBUSTNESS GAPS IN SEMANTIC PARSING MODELS UTILIZING DEEP LEARNING

(71) Applicant: Adobe Inc., San Jose, CA (US)

(72) Inventors: Neha Srikanth, College Park, MD (US); Ani Nenkova, Philadelphia, PA (US); Victor Soares Bursztyn, Mountain View, CA (US)

(21) Appl. No.: 19/050,382

(22) Filed: Feb. 11, 2025

(51) Int. Cl. G06F 16/2452; G06F 16/28; G06F 40/30

(52) U.S. Cl. CPC G06F 16/24522; G06F 16/285; G06F 40/30

(57) ABSTRACT

The present disclosure relates to systems, non-transitory computer-readable media, and methods for discovering and mitigating robustness gaps in semantic parsing models utilizing deep learning. For example, in one or more embodiments, the disclosed systems extract, utilizing a natural language processing model, predicates from a set of semantic parsing examples comprising natural language queries and corresponding structural representations. Further, the disclosed systems determine clusters of semantic parsing examples according to similarities between respective predicates from the semantic parsing examples. Moreover, the disclosed systems generate, utilizing a target semantic parsing model, predicted structural representations of the natural language queries and determine respective correctness values for the clusters based on comparing the predicted structural representations and the corresponding structural representations. In some embodiments, the disclosed systems identify robustness gaps in the target semantic parsing model based on the respective correctness values and implement mitigating actions to address the identified gaps.

### BACKGROUND

Recent years have seen significant improvements in artificial intelligence technology. For example, many organizations use machine learning models for various tasks. Many of these tasks are complex and frequently lead to inaccurate and/or widely varying results across different models. Moreover, due to the inherent complexity and diversity of the various models available, it is difficult to ascertain specific strengths and weaknesses of a model and how such strengths and weaknesses compare to other models. Accordingly, conventional systems suffer from limitations in terms of accuracy, flexibility, and efficiency due to a lack of insight into robustness gaps when selecting, implementing, and/or modifying machine learning models.

### SUMMARY

Embodiments of the present disclosure provide benefits and/or solve one or more of the foregoing or other problems in the art with systems, non-transitory computer-readable media, and methods for discovering and mitigating robustness gaps in deep learning models. For example, in one or more embodiments, the disclosed systems extract succinct and discrete features from example pairs of natural language queries and corresponding structural representations and identify clusters of the example pairs sharing similar extracted features. Having identified clusters of example pairs, the disclosed systems evaluate one or more semantic parsing models utilizing the natural language queries of the example pairs and observe cross-cluster differences in correctness of results output by the one or more semantic parsing models. To illustrate, in some embodiments, the disclosed systems determine correctness scores corresponding to respective clusters for each target semantic parsing model by comparing respective outputs with the structural representations provided by the example pairs. Also, in some embodiments, the disclosed systems provide various measures for mitigating robustness gaps identified by correctness scores of the respective clusters to improve model accuracy.

Additional features and advantages of one or more embodiments of the present disclosure are outlined in the description which follows, and in part can be determined from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates an example system environment in which a semantic parsing assessment system operates in accordance with one or more embodiments.

FIG. 2 illustrates an overview of the semantic parsing assessment system discovering and mitigating robustness gaps in semantic parsing models in accordance with one or more embodiments.

FIG. 3A illustrates the semantic parsing assessment system determining predicate feature vectors from semantic parsing examples in accordance with one or more embodiments.

FIG. 3B illustrates the semantic parsing assessment system determining robustness gaps in semantic parsing models in accordance with one or more embodiments.

FIG. 3C illustrates the semantic parsing assessment system mitigating robustness gaps in semantic parsing models in accordance with one or more embodiments.

FIG. 4 illustrates an example user interface for interacting with the semantic parsing assessment system in accordance with one or more embodiments.

FIG. 5 illustrates exemplary experimental results of determining robustness gaps in semantic parsing models in accordance with one or more embodiments.

FIG. 6 illustrates a schematic diagram of the semantic parsing assessment system in accordance with one or more embodiments.

FIG. 7 illustrates a flowchart of a series of acts for discovering and mitigating robustness gaps in semantic parsing models in accordance with one or more embodiments.

FIG. 8 illustrates a block diagram of an example computing device for implementing one or more embodiments of the present disclosure.

### DETAILED DESCRIPTION

This disclosure describes one or more embodiments of a semantic parsing assessment system that discovers and mitigates robustness gaps on semantic parsing models utilizing deep learning. In particular, the semantic parsing assessment system utilizes a multi-phase framework to identify human-interpretable blind spots in target semantic parsing models based on example pairs of natural language queries and structural representations thereof. Current benchmarking methods generally involve reporting a model's overall accuracy on a test set consisting of independent examples, resulting in a narrow scoring of candidate models without insight into specific gaps in the robustness of individual models. As such, in some cases, a model with a higher indication of overall performance is selected when a different model would perform with greater accuracy on the particular types of inputs in use. The semantic parsing assessment system avoid such issue by allowing for discovery of blind spots via cluster-specific results and, in some embodiments, implements mitigating actions for targeted improvements in model accuracy.

For instance, in one or more embodiments, the semantic parsing assessment system elicits textual descriptions of a set of semantic parsing example pairs from a natural language processing model (e.g., a large language model) and builds a unified representation of the set of example pairs by extracting binary predicates from the textual descriptions. Based on binary vectors representing the extracted predicates, the semantic parsing assessment system utilizes a data clustering model to group the example pairs into human-interpretable clusters for targeted evaluation of a semantic parsing model or a set of candidate semantic parsing models. In some embodiments, for example, the semantic parsing assessment system utilizes one or more semantic parsing models to generate structural representations according to the natural language queries of the set of example pairs and evaluates the results to record within-cluster correctness for the one or more semantic parsing models.

To illustrate, in one or more embodiments the semantic parsing assessment system receives, generates, or otherwise identifies a set of semantic parsing examples comprising natural language queries and corresponding structural representations for evaluation of one or more target semantic parsing models. Moreover, in one or more embodiments, the semantic parsing assessment system extracts, utilizing a natural language processing model, a plurality of predicates from the set of semantic parsing examples. In some embodiments, for example, the semantic parsing assessment system extracts the plurality of predicates for the set of semantic parsing examples by prompting the natural language processing model to generate textual descriptions of the semantic parsing examples and/or determine binary logical expressions (e.g., predicate phrases) from the textual descriptions.

Furthermore, in one or more embodiments, the semantic parsing assessment system determines, utilizing a data clustering model, clusters of semantic parsing examples according to similarities between respective predicates of the plurality of predicates. In some embodiments, for example, the semantic parsing assessment system generates respective feature vectors indicating a presence or absence of each predicate of the plurality of predicates within respective semantic parsing examples of the set of semantic parsing examples. Based on the respective feature vectors, in such embodiments, the semantic parsing assessment system determines the clusters utilizing the data clustering model.

In some embodiments, the semantic parsing assessment system utilizes one or more target semantic parsing models (e.g., candidate models) to generate predicted structural representations of the natural language queries of the set of semantic parsing examples. Based on a comparison of the predicted structural representations and the corresponding structural representations of the set of semantic parsing examples, the semantic parsing assessment system determines respective correctness values for the clusters of semantic parsing examples in relation to each of the one or more target semantic parsing models. Also, in some embodiments, the semantic parsing assessment system suggests, selects, and/or utilizes a particular semantic parsing model from the one or more target semantic parsing models based on a comparison between the respective correctness values for the clusters in relation to the one or more target semantic parsing models.

Moreover, in one or more embodiments, the semantic parsing assessment system performs one or more mitigating action in light of the respective correctness values. In some embodiments, for example, in response to determining that a correctness value corresponding to a particular cluster falls below a threshold value, the semantic parsing assessment system generates at least one adversarial training example for training a target semantic parsing model and/or adjusts one or more parameters of a target semantic parsing model to reduce an error in relation to at least one predicate associated with the particular cluster.

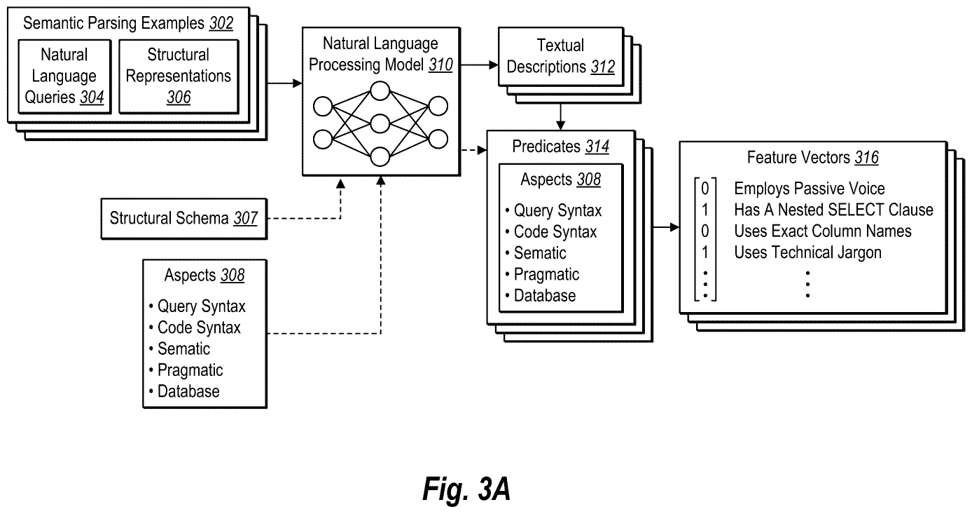

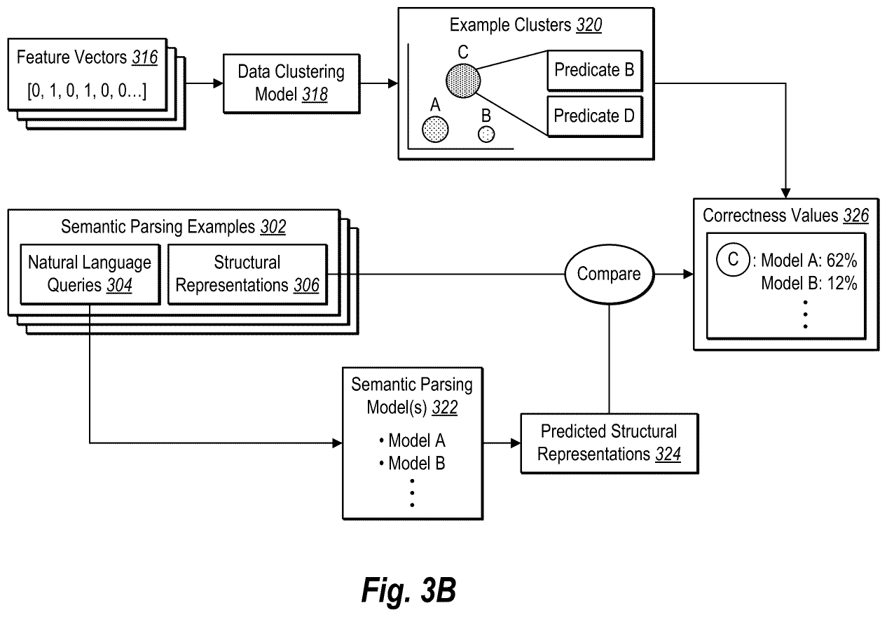

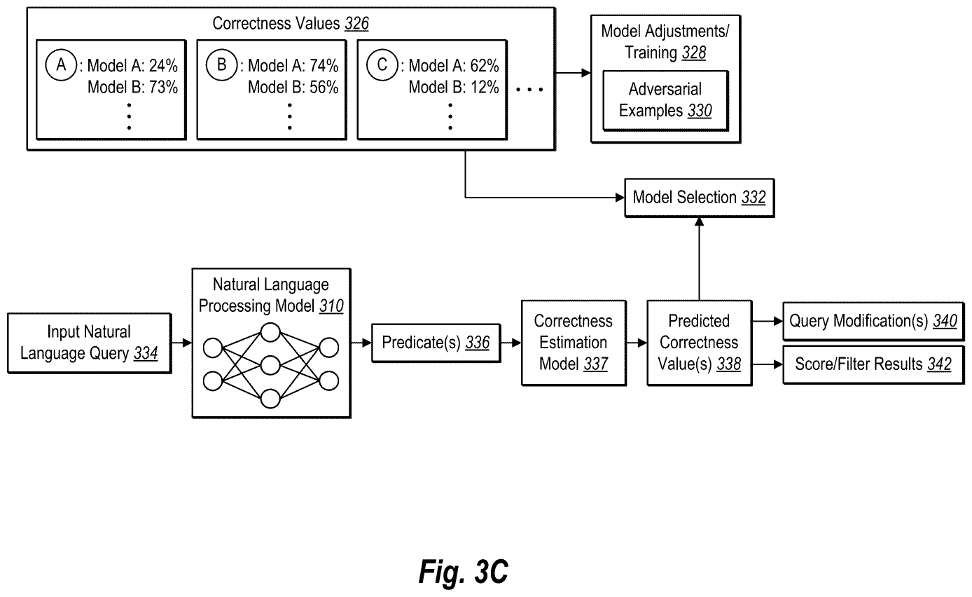

Additionally or alternatively, in some embodiments, the semantic parsing assessment system utilizes a natural language processing model to extract one or more predicates from an input natural language query and, based on the extracted predicates, generates a predicted correctness value for the input natural language query (e.g., utilizing a trained correctness estimation model). In some implementations, the semantic parsing assessment system generates, in response to determining that the predicted correctness value falls below a predetermined threshold value, an adjusted natural language query comprising at least one modification based on at least one predicate of the one or more predicates extracted from the input natural language query. Additional mitigating actions implemented according to one or more embodiments are described below (e.g., in relation to FIG. 3C).

As mentioned, existing systems have a number of technical shortcomings, particularly in terms of flexibility, accuracy, and efficiency when evaluating semantic parsing models to identify strengths and weaknesses for model selection and/or adjustment. For instance, current benchmarking methods generally involve reporting a model's overall accuracy on a test set consisting of independent examples, resulting in a narrow scoring of candidate models without insight into specific gaps in the robustness of individual models. As such, in some cases, a model with a higher indication of overall performance is selected when a different model would perform with greater accuracy on the particular types of inputs in use. In particular, by providing greater insight into the robustness gaps of each candidate model (e.g., based on cluster-specific correctness values), the semantic parsing assessment system enables selection of a semantic parsing model with higher accuracy of in generating structural representations from the particular dataset in use. Furthermore, by identifying interpretable strengths and weaknesses in semantic parsing models according to the embodiments described herein, the semantic parsing assessment system enables targeted and efficient modifications to potential natural language inputs, as well as modifications and training examples for improving the accuracy of the semantic parsing models themselves.

As suggested by the foregoing, the semantic parsing assessment system provides a variety of advantages relative to conventional systems. For example, by increasing the visibility of specific model strengths and weakness via human-interpretable features, the semantic parsing assessment system improves accuracy relative to conventional systems. Specifically, by extracting predicates from semantic parsing examples and determining clusters of the examples based on the extracted predicates, the semantic parsing assessment system overcomes the inaccuracies introduced by assessing models based on a narrow metric of overall performance on a given dataset. In particular, the semantic parsing assessment system improves the efficiency and accuracy of model assessment by providing a unified method to decompose a monolith dataset into smaller, human interpretable example sets that share similar properties and evaluating candidate models on such a dataset.

As demonstrated from the discussion above, the current application uses a variety of terms and phrases to describe the semantic parsing assessment system. For instance, as used herein, a “semantic parsing model” refers to a machine learning model configured to convert natural language into a structured, formal representation (e.g., a “structural representation”) of meaning interpretable by a computer application. To illustrate, a semantic parsing model can include database query generation models (e.g., models converting natural language queries into Structured Query Language (SQL) queries to retrieve information from a structured database), natural language interfaces for Application Programming Interfaces (APIs), code synthesis models for converting natural language to source code (e.g., Python), task-oriented dialogue interpretation systems, and so forth.

Relatedly, as used herein, the terms “natural language query” and “natural language prompt” refer to textual signals or inputs for a natural language processing model, such as a semantic parsing model, a large language model, or another model utilized by the semantic parsing assessment system according to embodiments of the present disclosure. Specifically, a natural language query or prompt refers to text consisting of human language that is provided to a machine learning model to generate a response, such as a structural representation or a natural language response.

Moreover, as used herein, the term “structural representation” refers to a formalized, machine-readable output that encodes the meaning of a natural language input in an established structure. In particular, structural representations typically comprise elements that capture the relationships, entities, and actions conveyed in the input text according to an established syntax. As such, the content and format of a structural representation can vary depending on the specific application and domain. To illustrate, examples of types of structural representations include but are not limited to logical forms, SQL queries, mathematical expressions, Abstract Meaning Representations (AMRs), dialogue states, and executable code.

Relatedly, as used herein, the term “structural schema” refers to the key components of a given type of structural representation and how they relate to one another and to the context of the given type of structural representation. To illustrate, a structural representation known as a SQL query generally consists of a SELECT clause specifying the columns or expressions to be retrieved from a subject database, a FROM clause specifying the table(s) from which data is to be retrieved, and various other conventionally defined clauses for accessing information within the subject database.

As mentioned previously, the semantic parsing assessment system utilizes a natural language processing model to generate descriptions and/or extract predicates from semantic parsing examples. For example, a natural language processing model includes artificial intelligence models capable of processing and generating natural language text. In particular, natural language processing models are trained on large amounts of data to learn patterns and rules of language. Accordingly, as used herein, a “natural language processing model” refers to one or more neural networks capable of processing natural language text to generate outputs that range from predictive outputs, analyses, or combinations of data within stored content items (e.g., large language models and language transformer models). In particular, a natural language processing model includes parameters trained (e.g., via deep learning) on large amounts of data to learn patterns and rules of language for summarizing and/or generating digital content. Examples of natural language processing models include but are not limited to BLOOM, Bard AI, ChatGPT (e.g., GPT-3.5, GPT-4, etc.), LaMDA, DialoGPT.

As mentioned above, in one or more embodiments, the semantic parsing assessment system extracts predicates from semantic parsing examples utilizing a natural language processing model. As used herein, the term “predicate” refers to a logical expression portraying a property or relationship associated with an entity (e.g., associated with a particular semantic parsing example). In particular, in some embodiments, a predicate includes a binary expression about a particular subject that evaluates to a Boolean value (e.g., true or false). To illustrate, some non-limiting examples of predicates extracted from semantic parsing examples according to one or more embodiments are provided below (e.g., in relation to FIGS. 3A and 4-5).

As also mentioned above, in some embodiments, the semantic parsing assessment system utilizes a data clustering model to determine clusters of semantic parsing examples. used herein, the term “data clustering model” refers to a model, such as an unsupervised machine learning model, that groups a set of data points into clusters based on their similarity. Relatedly, as used herein, the term “cluster” refers to a collection of data points that are similar according to a defined similarity or distance metric (e.g., a Euclidean distance) between features associated with respective data points. Examples of data clustering models include but are not limited to partition-based models (e.g., k-means or k-means++), density-based models (e.g., DBSCAN), hierarchical models (e.g., agglomerative clustering), and model-based clustering (e.g., Gaussian mixture models).

As mentioned, in some embodiments, the semantic parsing assessment system utilizes machine learning to perform one or more of the various tasks discussed herein. As used herein, a “machine learning model” refers to a computer algorithm or a collection of computer algorithms that can be trained and/or tuned based on inputs to approximate unknown functions. For example, a machine learning model can include a computer algorithm with branches, weights, or parameters that changed based on training data to improve for a particular task. Thus, a machine learning model can utilize one or more learning techniques to improve in accuracy and/or effectiveness. Example machine learning models include various types of decision trees, support vector machines, Bayesian networks, random forest models, or neural networks (e.g., deep neural networks).

Relatedly, as used herein, a “neural network” refers to a machine learning model of interconnected artificial neurons (e.g., organized in layers) that communicate and learn to approximate complex functions and generate outputs based on a plurality of inputs provided to the model. In some instances, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a transformer neural network, a generative adversarial neural network, a graph neural network, a diffusion neural network, or a multi-layer perceptron. In some embodiments, a neural network includes a combination of neural networks or neural network components.

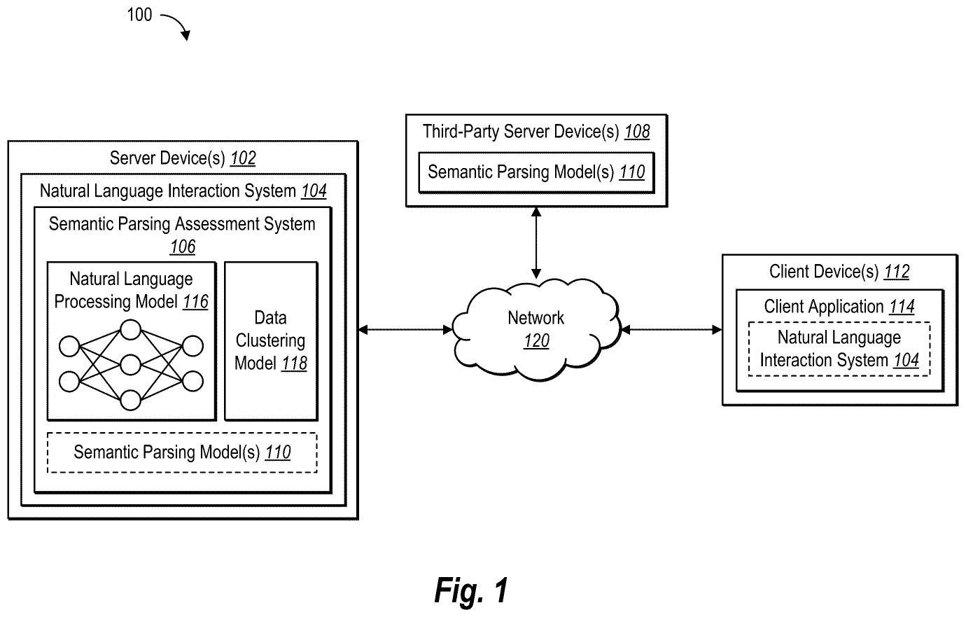

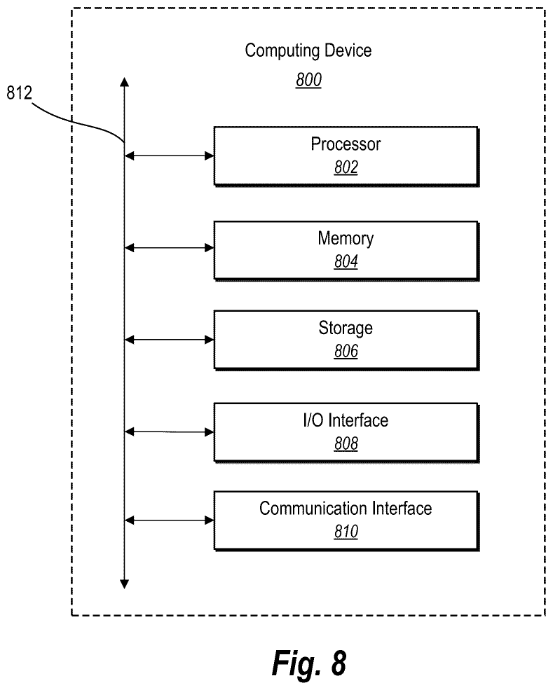

Additional detail regarding the semantic parsing assessment system will now be provided with reference to the figures. For example, FIG. 1 illustrates a schematic diagram of an exemplary system environment 100 in which a semantic parsing assessments system 106 operates. As illustrated in FIG. 1, the system environment 100 includes server device(s) 102, third-party server device(s) 108, client device(s) 112, and a network 120. The server device(s) 102, the client device(s) 112, and the third-party server device(s) 108 are communicatively coupled with each other either directly or indirectly (e.g., through the network 120). Moreover, the server device(s) 102 and the client device(s) 112 include one or more of a variety of computing devices (including one or more computing devices as discussed in greater detail in relation to FIG. 8).

Although the system environment 100 of FIG. 1 is depicted as having a particular number of components, the system environment 100 is capable of having any number of additional or alternative components (e.g., any number of servers, client devices, or other components in communication with the semantic parsing assessment system 106 via the network 120). Similarly, although FIG. 1 illustrates a particular arrangement of the server device(s) 102, the third party server device(s) 108, the client device(s) 112, and the network 120, various additional arrangements are possible.

As mentioned above, the system environment 100 includes the server device(s) 102. As shown in FIG. 1, the server device(s) 102 host a natural language interaction system 104 which includes or otherwise implements the semantic parsing assessment system 106. In one or more embodiments, the semantic parsing assessment system 106 utilizes a natural language processing model 116 to extract predicates from a set of semantic parsing examples (e.g., as described below in relation to FIG. 3A). Further, in some embodiments, the semantic parsing assessment system 106 utilizes a data clustering model 118 to determine clusters of semantic parsing examples based on the predicates extracted with the natural language processing model 116 (e.g., as described below in relation to FIG. 3B). Moreover, in one or more embodiments, the semantic parsing assessment system 106 accesses one or more semantic parsing model(s) 110 to generate predicted structural representations from natural language queries of the set of semantic parsing examples (e.g., as also described below in relation to FIG. 3B).

As further illustrated in FIG. 1, the system environment 100 includes the third-party server device(s) 108 which separately house the semantic parsing model(s) 110. Accordingly, in some instances, the semantic parsing assessment system 106 sends natural language queries to the third-party server device(s) 108 to utilize the semantic parsing model(s) 110. Alternatively, in some embodiments, one or more of the semantic parsing model(s) 110 are directly stored on the server device(s) 102 and/or the client device(s) 112.

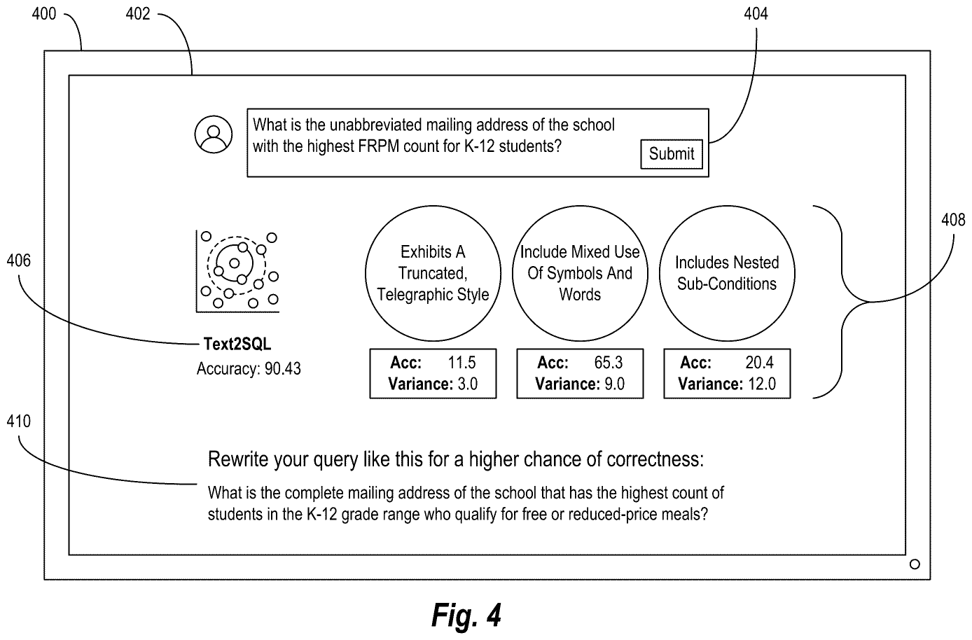

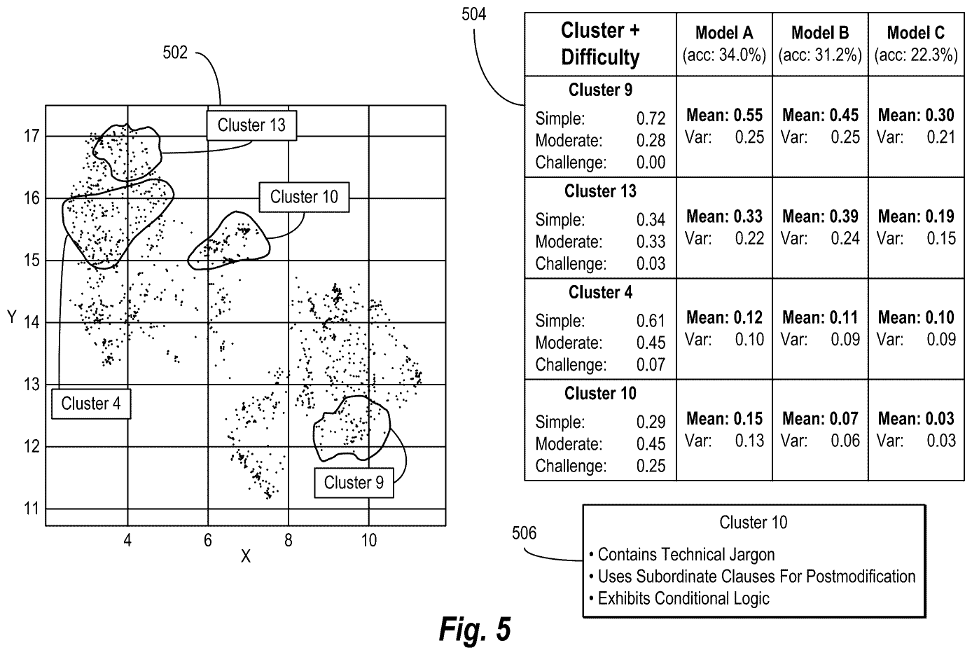

As also mentioned, the system environment 100 includes the client device(s) 112. In one or more embodiments, the client device(s) 112 include a computing device that is able to provide for display, elements within a graphical user interface, such as robustness assessment results, natural language query modifications/suggestions, or suggested models selections/adjustments, via a client application 114 (e.g., as discussed below in relation to FIGS. 4-5). For example, in some embodiments, the client device(s) 112 include smartphones, tablets, desktop computers, laptop computers, head-mounted-display devices, or other electronic devices. In particular, the client device(s) 112 include one or more applications (e.g., a digital analytics application, digital content application, or any application implementing or otherwise related to natural language processing) for sending instructions to assess one or more semantic parsing models for robustness gaps and/or determine mitigating measures in accordance with the semantic parsing assessment system 106. In particular, the client application 114 includes a software application installed on the client device(s) 112. Additionally, or alternatively, the client application 114 of the client device(s) 112 includes a software application hosted on the server device(s) 102 which may be accessed by the client device 112 through another application, such as a web browser or a native application, to access and/or interact with the natural language interaction system 104.

In one or more embodiments, the semantic parsing assessment system 106 receives an input natural language query from the client device 112 and extracts predicates therefrom via the natural language processing model 116 of the semantic parsing assessment system 106 in order to identify a cluster associated with the input natural language query or to generate, using a correction estimation model, a predicted correctness value for the input natural language query (e.g., without necessarily identifying or comparing the input natural language query to clusters of the aforementioned semantic parsing examples). Further, in some embodiments, the semantic parsing assessment system 106 determines, suggests, and/or implements at least one modification to the input natural language query in relation to at least one of the extracted predicates (e.g., to prepare the input natural language query for input to a particular semantic parsing model, as described below in relation to FIG. 4).

To provide an example implementation, in some embodiments, the natural language interaction system 104 (and the semantic parsing assessment system 106) on the server device(s) 102 supports the natural language interaction system 104 (and the semantic parsing assessment system 106) via the client application 114 on the client device(s) 112. For instance, in some cases, the natural language interaction system 104 on the server device(s) 102 trains the semantic parsing assessment system 106. In response, the semantic parsing assessment system 106, via the server device(s) 102, provides the trained semantic parsing assessment system 106 to the client device(s) 112. In other words, the client device(s) 112 obtain (e.g., download) the semantic parsing assessment system 106, the natural language processing model 116, the data clustering model 118, and/or the semantic parsing model(s) 110 from the server device(s) 102. Once downloaded, the semantic parsing assessment system 106 on the client device(s) 112 performs one or more of the actions described herein for discovering and/or mitigating robustness gaps in semantic parsing models in accordance with one or more embodiments independent from the server device(s) 102.

In alternative implementations, the semantic parsing assessment system 106 includes a web hosting application (e.g., the client application 114) that allows the client device(s) 112 to interact with content and services hosted on the server device(s) 102 and/or the third-party server device(s) 108. To illustrate, in one or more implementations, the client device(s) 112 access a software application supported by the server device(s) 102. In response, the semantic parsing assessment system 106 on the server device(s) 102 utilizes the natural language processing model 116, the data clustering model 118, and/or the semantic parsing model(s) 110. The server device(s) 102 provide the assessment and/or mitigation results to the client device(s) 112 for display (e.g., as described below in relation to FIG. 4).

To illustrate, in some cases, the semantic parsing assessment system 106 receives a set of semantic parsing examples via the client device 112. For example, the client device 112 transmits the set of semantic parsing examples to the server device(s) 102 via the client application 114. In response, the semantic parsing assessment system 106 on the server device(s) 102 generates clusters of semantic parsing examples based on predicates extracted from the set of semantic parsing examples and determines respective correctness values for the clusters in relation to the one or more semantic parsing model(s) 110, and causes the client device 112 to display the respective correctness values and, in some cases, additional information related to the clusters, predicates corresponding to each cluster, and/or the semantic parsing model(s) 110.

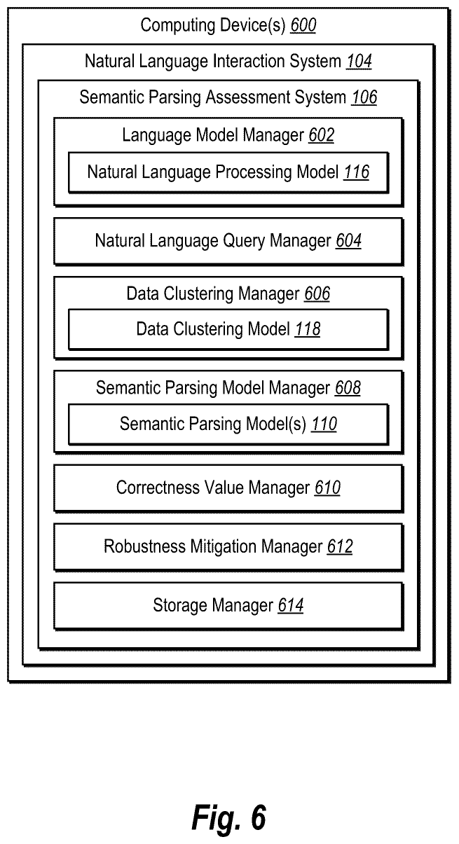

Indeed, in some embodiments, the semantic parsing assessment system 106 is implemented in whole, or in part, by the individual elements of the system environment 100. For instance, although FIG. 1 illustrates the semantic parsing assessment system 106 implemented or hosted on the server device(s) 102, different components of the semantic parsing assessment system 106 are able to be implemented by a variety of devices within the system environment 100. For example, one or more (or all) components of the semantic parsing assessment system 106 are implemented by a different computing device (e.g., the client device(s) 112) or a separate server from the server device(s) 102. Indeed, as shown in FIG. 1, the client device(s) 112 include the semantic parsing assessment system 106 via the natural language interaction system 104. Example components of the semantic parsing assessment system 106 will be described below with regard to FIG. 6.

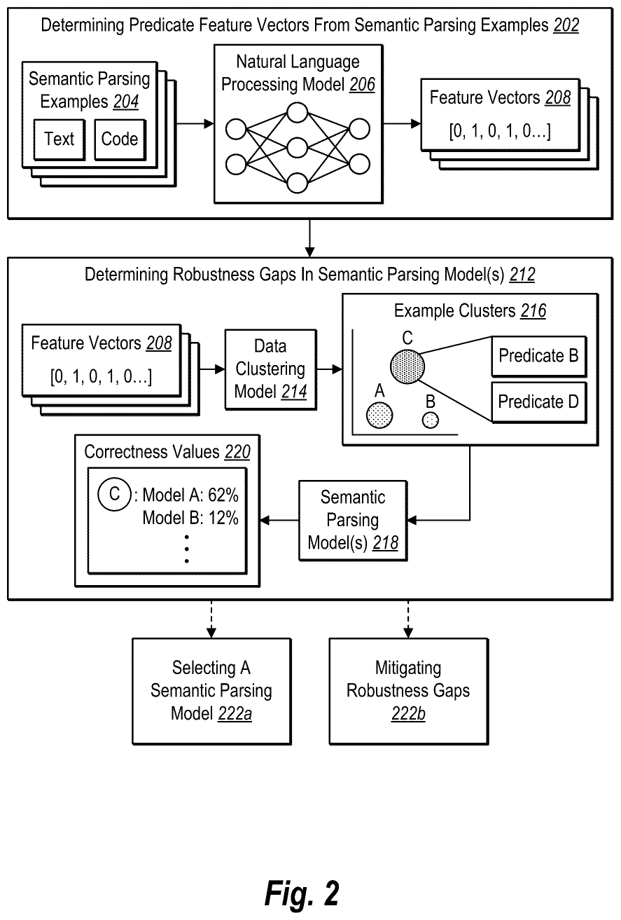

As mentioned above, in certain embodiments, the semantic parsing assessment system 106 discovers and mitigates robustness gaps in semantic parsing models utilizing one or more machine learning models. For example, FIG. 2 illustrates an overview of the semantic parsing assessment system 106 determining and mitigating robustness gaps in one or more semantic parsing model(s) 218 utilizing various models to analyze a set of semantic parsing examples 204.

As shown in FIG. 2, the semantic parsing assessment system 106 performs an act 202 of determining predicate feature vectors from the semantic parsing examples 204. As illustrated, the semantic parsing assessment system receives, determines, or otherwise identifies a dataset comprising the semantic parsing examples 204, including natural language queries (“Text”) and corresponding structural representations (“Code”). In some implementations, for example, the semantic parsing assessment system 106 determines or receives a representative dataset comprising exemplary natural language queries and corresponding structural representations for a particular user, application, or other context.

As also shown in FIG. 2, the semantic parsing assessment system 106 utilizes a natural language processing model 206 to extract feature vectors 208 from the semantic parsing examples 204 (e.g., as further described below in relation to FIG. 3A). In particular, in one or more embodiments, the semantic parsing assessment system 106 extracts a plurality of predicates (e.g., binary expressions) from the semantic parsing examples 204 and represents the predicates for each semantic parsing example as a set of Boolean operators (e.g., “1” or “0”) within a respective feature vector of the feature vectors 208. Accordingly, by generating the feature vectors 208, the semantic parsing assessment system 106 provides an interpretable, unified representation of the semantic parsing examples 204.

As further shown in FIG. 2, the semantic parsing assessment system 106 performs an act 212 of determining robustness gaps in the semantic parsing model(s) 218. As illustrated, the semantic parsing assessment system 106 utilizes a data clustering model 214 to determine example clusters 216 of the semantic parsing examples 204, as represented by the feature vectors 208 (e.g., as further described below in relation to FIG. 3B). As shown, for example, the data clustering model 214 determines the example clusters 216 based on respective similarities between the feature vectors 208, such that the respective semantic parsing examples included within a given cluster are associated with one or more shared predicates. As illustrated, for example, Cluster C of the example clusters 216 comprises Predicate B and Predicate D. In other words, each of the semantic parsing examples, as represented by their respective feature vectors, included in Cluster C comprise either or both of Predicate B and Predicate D. Additional examples of clusters determined by the semantic parsing assessment system 106 according to one or more embodiments are provided below (e.g., in relation to FIGS. 4-5). Moreover, as shown in FIG. 2, having determined the example clusters 216 of the semantic parsing examples 204, the semantic parsing assessment system 106 determines correctness values 220 for the semantic parsing model(s) 218 in relation to each example cluster (e.g., as further described below in relation to FIG. 3B). As illustrated, for example, the semantic parsing assessment system 106 determined respective correctness values of 62% for Model A and 12% for Model B of the semantic parsing models 218. Additional exemplary results of determining correctness values according to one or more embodiments are provided below (e.g., in relation to FIGS. 4-5).

As also shown in FIG. 2, in some embodiments, the semantic parsing assessment system 106 performs an act 222a of selecting a semantic parsing model and/or an act 222b of mitigating robustness gaps (e.g., as further described below in relation to FIG. 3C). In some embodiments, for example, the semantic parsing assessment system 106 suggests or selects a particular model of the semantic parsing models 218 based on the correctness values 220 for the particular model and/or for a particular cluster of the example clusters 216. Additionally or alternatively, in some embodiments, the semantic parsing assessment system 106 implements one or more mitigating measures to reduce an error of one or more of the semantic parsing models 218 in relation to predicate(s) indicated by a particular cluster of the example clusters 216 (e.g., a particular cluster having a respective correctness value below a threshold value). Some examples of such mitigating measures are provided below (e.g., in relation to FIG. 3C).

As mentioned above, in some embodiments, the semantic parsing assessment system 106 extracts predicates from a set of semantic parsing examples to generate a unified representation of the semantic parsing examples for assessment of one or more semantic parsing models. For example, FIG. 3A shows the semantic parsing assessment system 106 generating a set of feature vectors 316 representing respective predicates 314 extracted from a set of semantic parsing examples 302 utilizing a natural language processing model 310.

As shown in FIG. 3A, the semantic parsing assessment system 106 determines, receives, or otherwise identifies the semantic parsing examples 302, including natural language queries 304 and structural representations 306 corresponding to the natural language queries 304. In some implementations, for example, the structural representations 306 comprise exemplary structural representations of the natural language queries 304, such as reference example pairs identified or composed for evaluation and/or training of semantic parsing model(s) (e.g., ground truth examples). In some embodiments, the semantic parsing assessment system also provides a structural schema of the corresponding structural representations 306, such as a general description and/or established formatting for the particular type or category structural representations being produced (e.g., database queries or code snippets of a particular programming language).

As illustrated, the semantic parsing assessment system 106 utilizes the natural language processing model 310 to extract the predicates 314 from the semantic parsing examples 302. In one or more embodiments, for example, the semantic parsing assessment system 106 prompts the natural language processing model 310 to generate textual descriptions 312 of the semantic parsing examples 302, from which the semantic parsing assessment system 106 extracts the predicates 314. Alternatively, in some embodiments, the semantic parsing assessment system 106 extracts the predicates 314 directly from the semantic parsing examples 302 (e.g., without an intermediate step for generating the textual descriptions).

As a non-limiting example, a given semantic parsing example for models which convert natural language to SQL queries includes a natural language query of “What are the countries that have a greater surface area than that?” with a corresponding structural representation of “SELECT Name FROM country WHERE SurfaceArea>(SELECT min(SurfaceArea) FROM country WHERE Continent=‘Europe’”. In the provided example, the semantic parsing assessment system 106 utilizing the natural language processing model 310 to generate the following textual description:
First, the sentence makes us of a comparative structure with the phrase “greater . . . than.” The question utilizes a relative clause “that have a greater surface area than that,” where “that” functions as a demonstrative pronoun referring back to an implied surface area, which is clarified in the SQL query to be the minimum surface area of countries in Europe. This relative clause serves to restrict the set of countries to those meeting the specified condition, illustrating a common synthetic function of relative clauses. Moreover, the interrogative pronoun “What” at the beginning of the sentence signals a request for specific information, initiating a Wh- question. This Wh- question structure requires a syntactically complete response that aligns with the predicate “are the countries,” seeking to identify specific entities that fulfill the comparative condition. The hierarchical structure of the sentence shows the dependency of the main clause on the embedded relative clause. The main clause “What are the countries” is modified by the relative clause “that have a greater surface area than that,” enforcing a syntactic subordination relationship. Furthermore, the syntax displays an elided predicate “have a greater surface area than that [surface area],” where the complement of “that” is understood from context rather than explicitly stated, showcasing a common feature of English where certain syntactic elements can be omitted when they are inferable.

From a textual description generated for the given semantic parsing example (such as provided above), the semantic parsing assessment system 106, in the foregoing example implementation, extracts one or more of the following predicates: “uses a comparative structure,” “utilizes a relative clause,” “initiates a Wh- question,” “comprises a hierarchical sentence construction,” or “contains an elided predicate.” As illustrated by the foregoing non-limiting example, the semantic parsing assessment system 106 in some cases extracts multiple predicates from a respective textual description generated for a given semantic parsing example.

Moreover, in one or more embodiments, the semantic parsing assessment system 106 provides one or more natural language prompts to the natural language processing model 310 to cause the natural language processing model 310 to generate the textual descriptions 312 and/or extract the predicates 314. To generate the textual descriptions, in some embodiments, the one or more natural language prompts include the semantic parsing examples 302 and a request to identify and/or describe a set of aspects 308 within each of the semantic parsing examples 302. In some embodiments, for example, the aspects 308 includes one or more of a syntax of example queries, a syntax of corresponding structural representations, semantics between example queries and corresponding structural representations, pragmatic effects based on example context, or structural schema-related effects of example queries.

In addition or alternative to the aspects 308, in some embodiments, the semantic parsing assessment system provides a structural schema 307 of the corresponding structural representations 306. For example, the structural schema 307 includes a description and/or syntax of a particular schema, such as a database query syntax and description of the database contents, a dictionary for a particular type of programming code, and so forth. To illustrate, in one or more embodiments, the semantic parsing assessment system 106 prompts a large language model LLM to generate a given textual description D (e.g., of the textual descriptions 312) for a given semantic parsing example e (e.g., of the semantic parsing examples 302) according to the following:

$$D ( e ) = LLM ( {e}_{question ,} {e}_{sql} , {e}_{DB - schema} , A )$$

where e_{question} represents a natural language query, e_{sql} represents a corresponding structural representation, e_{DB-schema} represents a structural schema, and A represents one or more target aspects provided to the large language model LLM for extraction of the given textual description D.

To extract the predicates 314, in some embodiments, the one or more prompts further include a request to extract binary expressions from each of the generated textual descriptions 312. To illustrate, in one or more embodiments, the semantic parsing assessment system 106 extracts the predicates 314 from the textual descriptions 312 according to the following:

```
Input: Description corpus C comprising X descriptions D(eₓ), Aspects A
Output: List of proposed predicates (proposed_predicates) by model LLM
proposed_predicates = [ ]
for iteration i in n_iterations:
  S = random_sample (C, X = 50)
  pred_set = LLM (S, predicate_generation_prompt, A)
  proposed_predicates.extend(pred_set)
```

with the following example predicate generation prompt for input to the large language model LLM:
In this task you will need to come up with categories to group the text together based on a goal, where each category can be described with a natural language predicate. For example:
0. How are you doing?
1. How do I apply for visa?
2. Isn't it ridiculous?
3. How to get there by bus?
4. How is it going?
5. Aren't technological advancement good for the humanity?
Her is our goal: I want to cluster the questions based on their functionalities. Your responses are:
   “is a rhetorical question”
   “is meant for greetings”
   “is asking for practically userful information”
(note that all of them must be natural language predicates that can be validated on the given samples)
Here are some texts:
{S}
Here is our goal: {A}
Please suggest a few descriptions, one in a line, starting with “-” and surrounded by quotes “ ”. In terms of formatting, each of them needs to be a predicate about a text, for example:
   “uses double negation”
   “has a conservative stance”
Do not output anything else. (Note that the examples might not be goal related, and your response should be both formatted correct as above and related to the goal.)
Again, here's the goal: {A}. Your responses are:
   where S represents each sampled descriptions and A represents the target aspect(s) discussed above.

As mentioned above, in one or more embodiments the semantic parsing assessment system 106 prompts the natural language processing model 310 to extract the predicates 314 (e.g., the aforementioned binary expressions) directly from the semantic parsing examples 302. Further, in some embodiments, having extracted the predicates 314 from the semantic parsing examples 302, the semantic parsing assessment system 106 identifies and removes duplicate predicates (e.g., utilizing a deduplication model, such as but not limited to a fuzzy string matching model). In some cases, for example, the semantic parsing assessment system 106 determines that at least two predicates extracted from at least two respective semantic parsing examples comprise similar or identical meanings and, in response, modifies one or more of the at least two predicates to match one another (e.g., for inclusion within a same position with corresponding feature vectors as described below).

As also illustrated in FIG. 3A, in some embodiments, the semantic parsing assessment system 106 generates the predicates 314 organized according to the aspects 308. To illustrate, the following table provide a non-limiting example of predicates extracted from a set of semantic parsing examples according to target aspects of natural language query syntax (“Syntax”), SQL query syntax (“SQL Syntax”), semantic details (“Semantic”), pragmatic details (“Pragmatic”), and database-specific considerations (“Database”):

| | SQL | | | |
|---|---|---|---|---|
| Syntax | Syntax | Semantic | Pragmatic | Database |
| omits | includes a | involves | employs direct | uses exact |
| expected | subquery | nested | speech acts | column names |
| conjunctions | | logic | | from the |
| | | | | schema to |
| | | | | query for |
| | | | | specific values |
| employs | has an | has a direct | relies on | requires |
| passive voice | aggregate | relationship | conversational | commonsense |
| | function | with no | implicature | reasoning to |
| | | reasoning | | understand the |
| | | required | | implicit subject |
| | | | | of the table |
| | | | | entries |
| employs | uses a | requires | seeks specific | uses syntactic |
| technical | case | domain- | and measurable | variation to |
| jargon | expression | specific | information | describe a |
| | | knowledge | | condition |
| contains | contains a | involves | shows brevity | mirrors the |
| nested | GROUP | reasoning | at the cost of | structure of the |
| conditional | by clause | about unique | quantity | database |
| structures | | identifiers | maxim | schema |

As further illustrated in FIG. 3A, the semantic parsing assessment system 106 generates the feature vectors 316 respectively corresponding to the semantic parsing examples 302, the feature vectors 316 respectively indicating a presence or absence of each predicate of the predicates 314 within the semantic parsing examples 302. In particular, as shown in FIG. 3A, the feature vectors 316 include Boolean values representing the presence or absence of each predicate of the predicates 314 for a respective semantic parsing example of the semantic parsing examples 302. Accordingly, as mentioned above, the semantic parsing assessment system 106 generates a unified representation of the semantic parsing examples 302 in the form of the feature vectors 316 indicating which predicates correspond to each respective semantic parsing example of the set of semantic parsing examples 302.

As mentioned above, in some embodiments, the semantic parsing assessment system 106 generates clusters of semantic parsing examples according to similarities between respective predicates associated with the semantic parsing examples and determine correctness values for the clusters in relation to one or more semantic parsing models. For example, FIG. 3B shows the semantic parsing assessment system 106 determining example clusters 320 of the feature vectors 316 and determining respective correctness values 326 for the example clusters 320 in relation to one or more semantic parsing model(s) 322.

As shown in FIG. 3B, for instance, the semantic parsing assessment system 106 determines, receives or otherwise identifies the feature vectors 316 representing the semantic parsing examples 302 (e.g., as described above in relation to FIG. 3A). As illustrated, the semantic parsing assessment system 106 utilizes a data clustering model 318 to determine the example clusters 320 based on the feature vectors 316. In other words, in some embodiments, the semantic parsing assessment system 106 utilizes the data clustering model 318 to identify clusters of the feature vectors 316, such that each cluster comprises feature vectors representing semantic parsing examples with respectively overlapping predicates. To illustrate, FIG. 3B shows a Cluster C of the example clusters 320 comprising two predicates of the predicates 314, Predicate B and Predicate D. Accordingly, in the provided example, Cluster C includes semantic parsing examples which include either or both Predicate B and Predicate D (e.g., as indicated by their respective feature vectors).

As also shown in FIG. 3B, the semantic parsing assessment system 106 utilizes the semantic parsing model(s) 322 to generate predicted structural representations 324 of the natural language queries 304 from the semantic parsing examples 302. In some implementations, for example, the semantic parsing assessment system 106 selects or identifies a target suite of semantic parsing models for evaluation of their respective performance on semantic parsing examples within each of the example clusters 320. Alternatively, in some implementations, the semantic parsing assessment system 106 selects or identifies an individual semantic parsing model for evaluation across the example clusters 320. As illustrated, the semantic parsing assessment system 106 generates the predicted structural representations 324 by utilizing the semantic parsing model(s) 322 to process the natural language queries 304 respectively corresponding to each of the example clusters 320.

As further illustrated in FIG. 3B, the semantic parsing assessment system 106 determines the respective correctness values 326 for the example clusters 320 based on a comparison of the predicted structural representations 324 and the corresponding structural representations 306 from the semantic parsing examples 302 (e.g., utilizing the corresponding structural representations 306 as ground truth). Accordingly, in one or more implementations, the correctness values 326 include cluster-specific correctness values for each of the semantic parsing model(s) 322.

As mentioned, in one or more embodiments, the semantic parsing assessment system 106 determines a per-cluster correctness of the predicted structural representations 324 generated by each of the semantic parsing model(s) 322. In some embodiments, for example, the semantic parsing assessment system 106 determines clusters C (e.g., the example clusters 320) of a given dataset D (e.g., the semantic parsing examples 302) for a given model M (e.g., one of the semantic parsing models 322) according to the following:

$$C = \{ {c}_{1} … {c}_{n} \} = Phase 2 ( D , M )$$

where each cluster c has an associated correctness binary array E representing whether or not model M generates an accurate predicted structural representation of each corresponding natural language query within the dataset D. Accordingly, in some embodiments, the semantic parsing assessment system 106 determines blind spots of model M to be any cluster within C having a mean correctness value less than a threshold value a and/or a variance in correctness less than a threshold value b according to the following:

$$blind spot = \{ c ∈ C \vert μ ( E ) < a , var ( E ) < b \}$$

where each blind spot represents a robustness gap which can be identified and/or mitigated according to one or more embodiments (e.g., as further described below in relation to FIG. 3C).

To illustrate, FIG. 3B shows respective correctness values for the aforementioned Cluster C in relation to a Model A and a Model B of the semantic parsing models 322. Specifically, as illustrated in FIG. 3B, the semantic parsing assessment system 106 determines a correctness value of 62% for Model A with respect to the natural language queries included in Cluster C and a relatively lower correctness value for Model B in the same cluster. While not shown in FIG. 3B, in some embodiments, the correctness values 326 comprise both a mean correctness and a variance in the correctness of the predicted structural representations (e.g., as shown in FIG. 4).

As mentioned above, in some embodiments, the semantic parsing assessment system 106 determines, suggests, and/or implements one or more mitigating actions to reduce robustness gaps (e.g., blind spots) identified for one or more semantic parsing models (e.g., in view of correctness values determined for clusters of semantic parsing examples). For example, FIG. 3C shows the semantic parsing assessment system 106 determining, suggesting, and/or implementing various mitigations based at least in part on the correctness values 326 determined for the semantic parsing model(s) 322 in relation to the example clusters 320.

As shown in FIG. 3C, the semantic parsing assessment system 106 receives, determines, or otherwise identifies the correctness values 326, including a mean correctness for each model of the semantic parsing models 322 in relation to each cluster of the example clusters 320 (e.g., as further described below in relation to FIG. 5). Based on the correctness values 326, in some embodiments, the semantic parsing assessment system 106 implements model adjustments and/or training 328 to improve the accuracy of one or more of the semantic parsing models 322 (e.g., in relation to a predicate belonging to a particular cluster).

In some cases, for example, the semantic parsing assessment system 106 adjusts one or more parameters of a target semantic parsing model in response to determining that a correctness value for a particular cluster of the example clusters 320 in relation to the target semantic parsing model falls below a predetermined threshold value (e.g., to reduce an error in predicting structural representations based on input natural language queries comprising a predicate corresponding to the particular cluster. In some embodiments, the semantic parsing assessment system 106 generates, in response to determining that a correctness value for a particular cluster of the example clusters 320 in relation to the target semantic parsing model falls below a predetermined threshold value, one or more adversarial examples 330 for training one or more of the semantic parsing models 322. In one or more embodiments, for example, the semantic parsing assessment system 106 generates each of the adversarial examples 330 to include an example natural language query comprising at least one predicate associated with a particular cluster and a ground truth structural representation corresponding to the example natural language query. Additionally or alternatively, in some embodiments, the semantic parsing assessment system 106 rewrites or otherwise modifies one or more of the semantic parsing examples 302 to target the at least one predicate for training the target semantic parsing model. Accordingly, in some embodiments, the semantic parsing assessment system 106 provides and/or utilizes the adversarial examples 330 to train a target semantic parsing model to reduce an error between predicted structural representations generated by the target semantic parsing model based on the example natural language queries of the adversarial examples 330 and the ground truth structural representations of the adversarial examples 330.

As also shown in FIG. 3C, in some embodiments, the semantic parsing assessment system 106 provides a model selection 332 of a particular semantic parsing model of the semantic parsing models 322 based on the correctness values 326. In one or more embodiments, for example, the semantic parsing assessment system 106 suggests or selects the particular semantic parsing model from the semantic parsing models 322 based on the relative performance of the particular semantic parsing model across one or more of the clusters 320 according to the correctness values 326. In some implementations, the semantic parsing assessment system 106 provides the correctness values 326 to a user via a client device (e.g., as described below in relation to FIG. 5) and receives the model selection 332 from the user. Alternatively, in some implementations, the semantic parsing assessment system 106 automatically selects a particular semantic parsing model based on a comparison of the correctness values 326.

As also shown in FIG. 3C, in some cases, the semantic parsing assessment system 106 receives, determines, or otherwise identifies an input natural language query 334 comprising a prompt/request to generate a structural representation. In some embodiments, for example, the input natural language query 334 includes a proposed query input by a user or otherwise provided for generation of a structural representation (e.g., as described below in relation to FIG. 4). As illustrated, the semantic parsing assessment system 106 utilizes the natural language processing model 310 to extract one or more predicate(s) 336 from the input natural language query 334 (e.g., as described above in relation to the natural language queries 304 of the semantic parsing examples 302). Further, in some embodiments, the semantic parsing assessment system 106 generates a feature vector representing the one or more predicate(s) 336 extracted from the input natural language query 334 (e.g., a feature vector of the same or similar format as the feature vectors 316 generated for the semantic parsing examples 302).

As further shown in FIG. 3C, based on the predicate(s) 336 extracted by the natural language processing model 310, the semantic parsing assessment system 106 utilizes a correctness estimation model 337 to determine one or more predicted correctness value(s) 338 for the input natural language query 334 (e.g., in relation to one or more of the semantic parsing model(s) 322). In some embodiments, for example, the correctness estimation model 337 comprises a machine learning model, such as but not limited to a random forest model, trained to generate predicted correctness values for input natural language queries in relation to one or more target semantic parsing models. Moreover, in one or more embodiments, the correctness estimation model 337 is further configured and trained to extract feature importances corresponding to each predicate corresponding to an input natural language query.

Alternatively, in some embodiments, the semantic parsing assessment system 106 determines that one or more of the predicates 336 extracted from the input natural language query 334 correspond to a particular cluster of the example clusters 320 and, in response, assigns the input natural language query 334 to that particular cluster. In one or more embodiments, the semantic parsing assessment system 106 utilizes a trained machine learning model, such as a random forest classifier, to determine when a particular input query corresponds to a particular cluster of the example clusters 320. Furthermore, in some embodiments, the semantic parsing assessment system 106 utilizes a trained machine learning model to extract feature importances for each cluster of the example clusters 320 (e.g., a metric indicating the relative influence of each predicate of a given cluster on the respective correctness value for the given cluster).

Moreover, in some embodiments, the semantic parsing assessment system 106 determines the model selection 332 of a particular semantic parsing model of the semantic parsing models 322 based on the predicted correctness value(s) 338 for each model in relation to the input natural language query 334. In one or more embodiments, for example, the semantic parsing assessment system 106 suggests or selects the particular semantic parsing model from the semantic parsing models 322 based on the relative predicted performance of the particular semantic parsing model (e.g., compared to the other models represented by the predicted correctness value(s) 338) for the input natural language query 334.

Alternatively, in some implementations, the semantic parsing assessment system 106 receives the input natural language query 334 for processing by a first particular semantic parsing model and, in response to determining that the predicted correctness value 338 for the first particular semantic parsing model falls below a predetermined threshold value, selects an alternative semantic parsing model from the semantic parsing models 322 (e.g., a model with a higher predicted correctness value 338 for the input natural language query 334) to process the input natural language query 334. Moreover, in some implementations, the semantic parsing assessment system 106 utilizes a selection of models (e.g., based on a ranking of the semantic parsing models 322 according to the predicted correctness value(s) 338) from the semantic parsing models 322 to generate multiple predicted structural representations.

As also shown in FIG. 3C, in some embodiments, the semantic parsing assessment system 106 provides and/or implements one or more query modification(s) 340 to the input natural language query 334 based on at least one predicate corresponding to the input natural language query 334. As illustrated, the semantic parsing assessment system 106 utilizes the correctness estimation model 337 to generate the predicted correctness value(s) 338 for the input natural language query based on the predicate(s) 336 extracted from the input natural language query 334. Alternatively, the semantic parsing assessment system 106 assigns a predicted correctness value of the correctness values 326 to the input natural language query 334 based on determining that the input natural language query 334 comprises one or more predicates corresponding to a particular cluster of the example clusters 320. Accordingly, based on determining that the predicted correctness value 338 assigned to or generated for the input natural language query 334 falls below a predetermined threshold value, the semantic parsing assessment system 106 provides at least one suggestion to modify the input natural language query based on at least one predicate of the predicate(s) 336 corresponding to the input natural language query 334 (e.g., as further described below in relation to FIG. 4).

In some embodiments, for example, the semantic parsing assessment system 106 selects one or more predicates corresponding to clusters having a relatively high correctness value (e.g., high relative to other clusters and/or above a threshold value) and prompts a user or a natural language processing model to modify the input natural language query 334 based on the one or more selected predicates. In one or more embodiments, the semantic parsing assessment system 106 selects the one or more predicates for modifying the input natural language query 334 without considering predicates related to the structural representations 306 of the semantic parsing examples 302 (e.g., only selecting predicates related to the natural language queries 304 for modification of the input natural language query 334). Moreover, in some embodiments, the semantic parsing assessment system 106 selects the one or more predicates for modifying the input natural language query 334 without comparing the predicate(s) 336 extracted from the input natural language query 334 with the example clusters 320 (e.g., utilizing the correctness estimation model 337 to generate the predicted correctness value(s) 338 directly from the predicate(s) 336).

Moreover, as shown in FIG. 3C, in some embodiments, the semantic parsing assessment system 106 performs an act 342 of scoring and/or filtering semantic parsing results based on the correctness values 326. In some implementations, for example, the semantic parsing assessment system 106 determines, based on the predicted correctness value(s) 338 for the input natural language query 334, one or more confidence scores for one or more resultant structural representations generated from the input natural language query 334 utilizing one or more respective semantic parsing models of the semantic parsing models 322. Also, in some implementations, the semantic parsing assessment system 106 provides an indication (e.g., for display on a client device) that the input natural language query 334 comprises either a high or low confidence score. Alternatively, in some implementations, the semantic parsing assessment system 106 filters (e.g., withholds) resultant structural representations generated by semantic parsing model(s) having corresponding confidence scores with respect to the predicate(s) 336 which fall below a predetermined threshold value.

As mentioned above, in some embodiments, the semantic parsing assessment system 106 provides a user interface for discovering and mitigating robustness gaps in target semantic parsing model(s) according to one or more embodiments. For example, FIG. 4 shows the semantic parsing assessment system 106 providing a user interface 402 for display on a computing device 400 (e.g., client device 112, computing device 600, or computing device 800) for interacting with the semantic parsing assessment system 106.

As shown in FIG. 4, the user interface 402 provided by the semantic parsing assessment system 106 includes prompt 404 for an input natural language query. Based on the input natural language query entered, in the illustrated implementation, the semantic parsing assessment system 106 displays assessment results 408 for a target semantic parsing model 406, the assessment results 408 including correctness values for predicates identified within the input natural language query. In particular, the assessment results 408 include correctness values generated for the identified predicates, in relation to the target semantic parsing model 406 (e.g., as described above in relation to FIG. 3B).

As also shown in FIG. 4, the user interface 402 provided by the semantic parsing assessment system 106 includes a suggested modification 410 to the input natural language query entered within the prompt 404. As illustrated, the suggested modification 410 addresses at least one of the predicates having a relatively low correctness value (e.g., a correctness value below a predetermined threshold value) within the assessment results 408. Alternatively or additionally, the semantic parsing assessment system 106 suggests that the user rephrase the query to address at least one of the identified predicates. Accordingly, as mentioned previously, in some implementations the semantic parsing assessment system 106 provides suggested modifications to input natural language queries that target specific robustness gaps in a target semantic parsing model.

As mentioned above, in some embodiments, the semantic parsing assessment system 106 determines robustness gaps in semantic parsing models across clusters corresponding to human interpretable predicates extracted from semantic parsing examples. For example, FIG. 5 shows exemplary experimental results of determining and evaluating clusters of feature vectors representing predicates corresponding to semantic parsing examples using the semantic parsing assessment system 106.

As shown in FIG. 5, a scatter plot 502 of features vectors includes at least four identified clusters: Cluster 4, Cluster 9, Cluster 10, and Cluster 13. As mentioned above, each cluster identified by the semantic parsing assessment system 106 corresponds to a group of semantic parsing examples comprising similar predicates, as indicated by their respective feature vectors (e.g., as further described above in relation to FIG. 3B. Furthermore, FIG. 5 includes a table 504 of respective correctness values for the clusters identified in within the scatter plot 502. In the illustrated implementation, the respective correctness values include a mean correctness and a variance of correctness for each identified cluster in relation to multiple target semantic parsing models—Model A, Model B, and Model C). The table 504 also includes an overall accuracy rating for each of the target semantic parsing models, as well as within-cluster difficulty metrics (e.g., metrics indicating whether a particular cluster is generally problematic or difficult to accurately translate to a structural representation). To further, FIG. 5 includes an index 506 of predicates associated with Cluster 10.

Indeed, as indicated by the experimental results presented in FIG. 5, the semantic parsing assessment system 106 provides for discovery of interpretable robustness gaps in target semantic parsing models. As indicated in the table 504, for example, the overall accuracy of each target semantic parsing model varies significantly from the correctness values provided for each particular cluster of predicate features. Accordingly, the semantic parsing assessment system 106, according to one or more embodiments, enables selection and/or improvement of target semantic parsing models based on interpretable and unambiguous indications of model advantages and weaknesses. In particular, FIG. 5 indicates that natural language queries comprising one or more of the predicates of Cluster 10 generally result in significantly lower accuracies than natural language queries comprising predicates within Cluster 9. Indeed, as shown by index 506, the top features of Cluster 10 include “contains technical jargon,” “uses subordinate clauses for postmodification,” and “exhibits conditional logic.”. As such, Cluster 10 is a blind spot for Model B.

Indeed, as shown by FIG. 5, the semantic parsing assessment system 106, according to one or more embodiments, yields statistically significant gaps in cluster performance (as shown in FIG. 5): highlighting that certain models have certain strengths and weaknesses. This approach allows for a better grasp where and on what models succeed and fail. Furthermore, the semantic parsing assessment system 106 defines a model blind spot as a cluster of examples with low mean correctness and low variance in correctness, in other words, a set of examples for which the model is consistently bad. This approach allows for automatic detection of model blind spots with minimal human intervention. Furthermore, the semantic parsing assessment system 106 provides a fine-grained way for comparison of models in a more nuanced manner than by simply comparing accuracies in a leaderboard.

FIG. 5 further illustrates this ability of the semantic parsing assessment system 106 to provide nuanced distinctions to aid in selecting the best model. For example, as shown by FIG. 5, for the same dataset, practitioners only looking a leaderboard to compare two models (Model A and Model B) may simply conclude that the two models have comparable performance, with Model A slightly outperforming Model B. However, upon closer inspection, there are classes of examples where Model B, the worse performing model, slightly outperforms Model A (Cluster 13). If a practitioner primarily has examples in their custom dataset that resemble examples in Cluster 13, they may find Model B (which is a smaller model than Model A) is a better fit for their use case.

The semantic parsing assessment system 106 uses feature importance to identify human-interpretable features of different clusters, allowing practitioners to understand the qualities of examples that make them difficult or easy for different models. In one or more embodiments, the semantic parsing assessment system 106 trains a random forest classifier for each cluster to recognize when an example belongs or does not belong to a cluster, and extracts feature importances from the random forest for each cluster. Doing so yields human-interpretable features of examples that the model is likely to get correct or incorrect.

Turning to FIG. 6, additional detail will now be provided regarding various components and capabilities of the semantic parsing assessment system 106. In particular, FIG. 6 illustrates an example schematic diagram of a computing device 600 (e.g., the server device(s) 102 and/or the client device(s) 112) implementing the semantic parsing assessment system 106 in accordance with one or more embodiments. As illustrated in FIG. 6, the semantic parsing assessment system 106 as implemented by the computing device 600 includes a language model manager 602, a natural language query manager 604, a data clustering manager 606, a semantic parsing model manager 608, a correctness value manager 610, a robustness mitigation manager 612, and a storage manager 614.

The language model manager 602 stores, accesses, and/or implements one or more natural language processing model models according to one or more embodiments. For example, the language model manager 602 utilizes a natural language processing model 116 to generate textual descriptions and/or extract predicates from semantic parsing examples or input natural language queries, as described above in relation to FIGS. 2 and 3A-3C.

The natural language query manager 604 identifies, determines, stores, generates and/or provides natural language queries to the semantic parsing assessment system 106 according to one or more embodiments. For example, the natural language query manager 604 provides natural language queries to a natural language processing model 116 to generate textual descriptions and/or extract predicates, as described above in relation to FIGS. 2 and 3A-3C. For example, the natural language query manager 604 provides natural language queries to one or more semantic parsing models 110 to generate predicted structural representations, as described above in relation to FIGS. 2 and 3B. For example, the natural language query manager 604 provides, suggests, and/or implements modifications to an input natural language query based on respective correctness scores for a cluster identified for the input natural language query, as discussed above in relation to FIGS. 3C and 4.

The data clustering manager 606 stores, accesses, and/or implements a data clustering model 118 to generate or determine data clusters and determines, identifies, stores, and/or accessed data clusters generated or determined by a data clustering model 118 according to one or more embodiments. For example, the data clustering manager 606 utilizes a data clustering model 118 to determine clusters of semantic parsing examples based on respective feature vectors and provides the identified clusters for assessment of one or more target semantic parsing models 110, as described above in relation to FIGS. 2 and 3B.

The semantic parsing model manager 608 stores, accesses, and/or implements semantic parsing models 110 to generate predicted structural representations from natural language queries according to one or more embodiments. For example, the semantic parsing model manager 608 utilizes one or more target semantic parsing models 110 to generate predicted structural representations of natural language queries from a set of semantic parsing examples for comparison with corresponding structural language queries from the set of semantic parsing examples, as discussed above in relation to FIGS. 2 and 3B. For example, the semantic parsing model manager 608 adjusts parameters or otherwise trains one or more target semantic parsing models 110 in response to assessment results generated by the semantic parsing assessment system 106 in relation to the one or more target semantic parsing models 110, as discussed above in relation to FIGS. 2 and 3C.

The correctness value manager 610 identifies, determines, generates, compares, and/or provides correctness values corresponding to clusters of semantic parsing examples in relation to target semantic parsing models 110 in accordance with one or more embodiments. For example, the correctness value manager 610 determines respective correctness values for clusters identified by the semantic parsing assessment system 106 based on feature vectors corresponding to a set of semantic parsing examples, as described above in relation to FIGS. 2 and 3B. For example, the correctness value manager 610 provides, via a user interface of a client device, correctness values for identified clusters in relation to one or more target semantic parsing models 110, as discussed above in relation to FIGS. 4-5. Moreover, in some embodiments, the correctness value manager 610 stores, accesses, and/or implements a correctness estimation model configured and trained to generate predicted correctness values for input natural language queries based on extracted predicates, as discussed above in relation to FIG. 3C).

The robustness mitigation manager 612 determines, provides, suggests, and/or implements mitigation measures for robustness gaps discovered by the semantic parsing assessment system 106 in accordance with one or more embodiments. For example, the robustness mitigation manager 612 suggests and/or selects a particular semantic parsing model from a set of semantic parsing models and/or adjusts or trains the particular semantic parsing model based on correctness values generated in relation to the particular semantic parsing model, as described above in relation to FIGS. 2 and 3C.

The storage manager 614 stores and/or access semantic parsing examples, textual descriptions, extracted predicates, feature vectors, correctness values, language prompts, structural schema, target aspects, and pre-trained machine learning models and neural networks in accordance with one or more embodiments.

Each of the components 602-614 of the semantic parsing assessment system 106 can include software, hardware, or both. For example, the components 602-614 can include one or more instructions stored on a computer-readable storage medium and executable by processors of one or more computing devices, such as a client device or server device. When executed by the one or more processors, the computer-executable instructions of the semantic parsing assessment system 106 can cause the computing device(s) to perform the methods described herein. Alternatively, the components 602-614 can include hardware, such as a special-purpose processing device to perform a certain function or group of functions. Alternatively, the components 602-614 of the semantic parsing assessment system 106 can include a combination of computer-executable instructions and hardware.

Furthermore, the components 602-614 of the semantic parsing assessment system 106 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 602-614 of the semantic parsing assessment system 106 may be implemented as a stand-alone application, such as a desktop or mobile application. Furthermore, the components 602-614 of the semantic parsing assessment system 106 may be implemented as one or more web-based applications hosted on a remote server. Alternatively, or additionally, the components 602-614 of the semantic parsing assessment system 106 may be implemented in a suite of mobile device applications or “apps.” For example, in one or more embodiments, the semantic parsing assessment system 106 can comprise or operate in connection with digital software applications such as ADOBE® JOURNEY OPTIMIZER, ADOBE® ADVERTISING CLOUD, and/or ADOBE® EXPERIENCE PLATFORM. The foregoing are either registered trademarks or trademarks of Adobe Inc. in the United States and/or other countries.

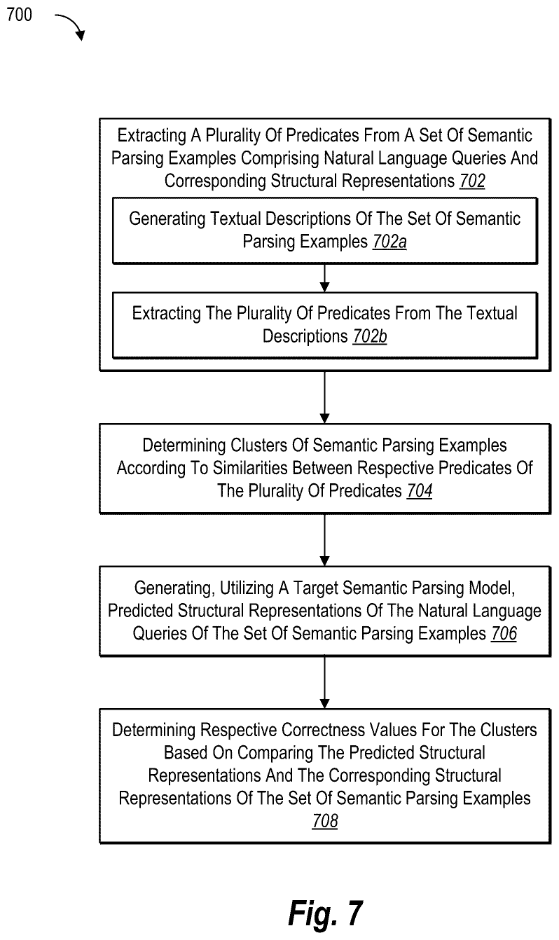

FIGS. 1-6, the corresponding text, and the examples provide a number of different systems, methods, and non-transitory computer readable media for discovering and mitigating robustness gaps in semantic parsing models in accordance with one or more embodiments. In addition to the foregoing, embodiments can also be described in terms of flowcharts comprising acts for accomplishing a particular result, as shown in FIG. 7. While FIG. 7 illustrates acts according to some embodiments, alternative embodiments may omit, add to, reorder, and/or modify any of the acts shown in FIG. 7. The acts of FIG. 7 can be performed as part of a computer-implemented method. Alternatively, a non-transitory computer readable medium can comprise instructions, that when executed by one or more processors, cause a computing device to perform the acts of FIG. 7. In still further embodiments, a system can perform the acts of FIG. 7. Additionally, the acts described herein may be repeated or performed in parallel with one another or in parallel with different instances of the same or other similar acts.

FIG. 7 illustrates an example series of acts 700 for determining, with respect to a target semantic parsing model, correctness values for clusters of semantic parsing examples from a set of semantic parsing examples (e.g., indicating strengths and weaknesses in the robustness of the target semantic parsing model). As shown in FIG. 7, the series of acts 700 includes an act 702 of extracting a plurality of predicates from a set of semantic parsing examples comprising natural language queries and corresponding structural representations. The series of acts 700 includes an act 704 of determining clusters of semantic parsing examples according to similarities between respective predicates of the plurality of predicates. The series of acts 700 includes an act 706 of generating, utilizing a target semantic parsing model, predicted structural representations of the natural language queries of the set of semantic parsing examples. The series of acts 700 includes an act 708 of determining respective correctness values for the clusters based on comparing the predicted structural representations and the corresponding structural representations of the set of semantic parsing examples. As also illustrated, in one or more embodiments, the act 702 comprises, in one or more embodiments, an act 702a of generating textual descriptions of the set of semantic parsing examples and an act 702b of extracting the plurality of predicates from the textural descriptions.

In particular, in some embodiments, the series of acts 700 includes extracting, utilizing a natural language processing model, a plurality of predicates from a set of semantic parsing examples comprising natural language queries and corresponding structural representations. The series of acts 700 also includes determining, utilizing a data clustering model, clusters of semantic parsing examples according to similarities between respective predicates of the plurality of predicates. The series of acts 700 also includes generating, utilizing a target semantic parsing model, predicted structural representations of the natural language queries of the set of semantic parsing examples. The series of acts 700 further includes determining respective correctness values for the clusters of semantic parsing examples based on comparing the predicted structural representations and the corresponding structural representations of the set of semantic parsing examples. Also, in one or more embodiments, the series of acts 700 includes generating, utilizing the natural language processing model, textual descriptions of the set of semantic parsing examples and extracting the plurality of predicates from the textual descriptions.

Furthermore, in one or more embodiments, generating the textual descriptions of the set of semantic parsing examples includes providing, to the natural language processing model, one or more natural language prompts comprising the set of semantic parsing examples, a structural schema of the corresponding structural representations of the set of semantic parsing examples, and a request to identify, within the set of semantic parsing examples, a set of target aspects comprising one or more of a syntax of example queries, a syntax of corresponding structural representations, semantics between example queries and corresponding structural representations, pragmatic effects based on example context, or structural schema-related effects of example queries.

In addition, in some embodiments, the series of acts 700 includes generating, for respective semantic parsing examples of the set of semantic parsing examples, respective feature vectors indicating a presence or absence of each predicate of the plurality of predicates within the respective semantic parsing examples and determining, utilizing the data clustering model, the clusters of semantic parsing examples based on comparing the respective feature vectors.

Moreover, in one or more embodiments, the series of acts 700 includes generating, utilizing an additional target semantic parsing model, additional predicted structural representations of the natural language queries of the set of semantic parsing examples and determining additional respective correctness values for the clusters of semantic parsing examples based on comparing the additional predicted structural representations and the corresponding structural representations of the set of semantic parsing examples. In some embodiments, the series of acts 700 includes selecting the target semantic parsing model or the additional target semantic parsing model based on a comparison between the respective correctness values and the additional respective correctness values for the clusters of semantic parsing examples.

In one or more embodiments, the series of acts 700 includes receiving an input natural language query requesting generation of a structural representation, determining, utilizing the natural language processing model, one or more predicates corresponding to the input natural language query and generating, utilizing a correctness estimation model, a predicted correctness value indicating a likelihood that the target semantic parsing model will generate an accurate structural representation from the input natural language query. In addition, in some embodiments, the series of acts 700 includes providing, in response to determining that the predicted correctness value generated for the input natural language query falls below a predetermined threshold value, at least one suggestion to modify the input natural language query based on at least one predicate of the one or more predicates corresponding to the input natural language query. Also, in some embodiments, the series of acts 700 includes utilizing the natural language processing model to modify, in response to determining that the predicted correctness value generated for the input natural language query falls below a predetermined threshold value, the input natural language query with respect to at least one predicate of the one or more predicates corresponding to the input natural language query.

In some embodiments, the series of acts 700 includes modifying, in response to determining that a correctness value of the respective correctness values corresponding to a particular cluster of the clusters of semantic parsing examples falls below a predetermined threshold value, one or more parameters of the target semantic parsing model to reduce an error between the predicted structural representations and the corresponding structural representations associated with the particular cluster. In one or more embodiments, the series of acts 700 includes generating, in response to determining that a correctness value of the respective correctness values corresponding to a particular cluster of the clusters of semantic parsing examples falls below a predetermined threshold value, at least one adversarial training example comprising (i) an example natural language query including at least one predicate associated with the particular cluster and (ii) a ground truth structural representation corresponding to the example natural language query.

In particular, in some embodiments, the series of acts 700 includes generating, utilizing a natural language processing model, textual descriptions of a set of semantic parsing examples comprising natural language queries and corresponding structural representations; extracting, from the textual descriptions, a plurality of predicates for the set of semantic parsing examples. The series of acts 700 also includes determining, utilizing a data clustering model, clusters of semantic parsing examples according to similarities between respective predicates of the plurality of predicates. The series of acts 700 includes generating, utilizing a target semantic parsing model, predicted structural representations of the natural language queries of the set of semantic parsing examples. The series of acts 700 also includes determining respective correctness values for the clusters of semantic parsing examples based on comparing the predicted structural representations and the corresponding structural representations of the set of semantic parsing examples.

Furthermore, in one or more embodiments, extracting the plurality of predicates for the set of semantic parsing examples includes utilizing the natural language processing model to determine binary logical expressions from the textual descriptions of the set of semantic parsing examples. Also, in some embodiments, the series of acts 700 includes generating, for respective semantic parsing examples of the set of semantic parsing examples, respective feature vectors indicating a presence or absence of each predicate of the plurality of predicates within the respective semantic parsing examples and determining, utilizing the data clustering model, the clusters of semantic parsing examples based on comparing the respective feature vectors.

Moreover, in some embodiments, generating the textual descriptions of the set of semantic parsing examples includes utilizing the natural language processing model to process the natural language queries, the corresponding structural representations, and a structural schema of the corresponding structural representations. In one or more embodiments, the structural schema of the corresponding structural representations comprises one or more of an indication of a domain-specific language, a structural description of a target database, or a template structural representation.

In particular, in one or more embodiments, the series of acts 700 includes receiving an input natural language query requesting generation of a structural representation, extracting, utilizing a natural language processing model, predicates corresponding to the input natural language query, generating, utilizing a correctness estimation model, a predicted correctness value indicating a likelihood that a given semantic parsing model will generate an accurate structural representation from the input natural language query, and generating, in response to determining that the predicted correctness value falls below a predetermined threshold value, an adjusted natural language query comprising at least one modification based on at least one predicate of the predicates extracted from the input natural language query.

Furthermore, in some embodiments, generating the adjusted natural language query includes providing, to a user via a client device, at least one suggestion to modify the input natural language query based on the at least one predicate of the predicates corresponding to the input natural language query and receiving, via the client device, the adjusted natural language query. In some embodiments, generating the adjusted natural language query includes utilizing a natural language processing model to modify the input natural language query with respect to the at least one predicate of the predicates corresponding to the input natural language query.

Moreover, in one or more embodiments, the series of acts 700 includes determining, utilizing the correctness estimation model and based on the predicates corresponding to the input natural language query, an additional predicted correctness value corresponding to an alternative semantic parsing model and providing, in response to determining that the additional predicted correctness value is greater than the predicted correctness value for the given semantic parsing model, a suggestion to utilize the alternative semantic parsing model to generate a structural representation for the input natural language query.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media. Non-transitory computer-readable storage media (devices) includes optical and/or non-optical memory, disks, or caches that store computer data interpretable by one or more processors to execute particular functions as described herein. A “network” is defined as one or more data links that enable the transport of electronic data between computer systems and/or modules and/or other electronic devices. Information is transferred or provided over a network (either hardwired, wireless, or a combination of hardwired or wireless) to a computer to carry program code in the form of computer-executable instructions or data structures and which can be accessed by a general purpose or special purpose computer.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code.

Embodiments of the present disclosure can also be implemented in cloud computing environments. In this description, “cloud computing” is defined as a model for enabling on-demand network access to a shared pool of configurable computing resources. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth.

FIG. 8 illustrates, in block diagram form, an example computing device 800 (e.g., the computing device 800, the client device(s) 108, and/or the server device(s) 102) that may be configured to perform one or more of the processes described above. As shown by FIG. 8, the computing device can comprise a processor(s) 802, memory 804, a storage device 806, an I/O interface 808, and a communication interface 810.

In particular embodiments, processor(s) 802 includes hardware for executing instructions, such as those making up a computer program. As an example, and not by way of limitation, to execute instructions, processor(s) 802 may retrieve (or fetch) the instructions from an internal register, an internal cache, memory 804, or a storage device 806 and decode and execute them. The computing device 800 includes memory 804, which is coupled to the processor(s) 802. The memory 804 may be used for storing data, metadata, and programs for execution by the processor(s). The memory 804 may include one or more of volatile and non-volatile memories. The memory 804 may be internal or distributed memory. The computing device 800 includes a storage device 806 includes storage for storing data or instructions. As an example, and not by way of limitation, storage device 806 can comprise a non-transitory storage medium described above. The computing device 800 also includes one or more input or output (“I/O”) devices/interfaces 808, which are provided to allow a user to provide input to (such as user strokes), receive output from, and otherwise transfer data to and from the computing device 800. These I/O devices/interfaces 808 may include a mouse, keypad or a keyboard, a touch screen, camera, optical scanner, network interface, modem, other known I/O devices or a combination of such I/O devices/interfaces 808.

The computing device 800 can further include a communication interface 810. The communication interface 810 can include hardware, software, or both. The communication interface 810 can provide one or more interfaces for communication (such as, for example, packet-based communication) between the computing device and one or more other computing devices (e.g., computing device 800) or one or more networks. The computing device 800 can further include a bus 812. The bus 812 can comprise hardware, software, or both that couples components of computing device 800 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
extracting, utilizing a natural language processing model, a plurality of predicates from a set of semantic parsing examples comprising natural language queries and corresponding structural representations;
determining, utilizing a data clustering model, clusters of semantic parsing examples according to similarities between respective predicates of the plurality of predicates;
generating, utilizing a target semantic parsing model, predicted structural representations of the natural language queries of the set of semantic parsing examples; and
determining respective correctness values for the clusters of semantic parsing examples based on comparing the predicted structural representations and the corresponding structural representations of the set of semantic parsing examples.

2. The computer-implemented method of claim 1, further comprising:
generating, utilizing the natural language processing model, textual descriptions of the set of semantic parsing examples; and
extracting the plurality of predicates from the textual descriptions.

3. The computer-implemented method of claim 2, wherein generating the textual descriptions for the set of semantic parsing examples comprises providing, to the natural language processing model, one or more natural language prompts comprising:
the set of semantic parsing examples;
a structural schema of the corresponding structural representations of the set of semantic parsing examples; and
a request to identify, within the set of semantic parsing examples, a set of target aspects comprising one or more of a syntax of example queries, a syntax of corresponding structural representations, semantics between example queries and corresponding structural representations, pragmatic effects based on example context, or structural schema-related effects of example queries.

4. The computer-implemented method of claim 1, further comprising:
generating, for respective semantic parsing examples of the set of semantic parsing examples, respective feature vectors indicating a presence or absence of each predicate of the plurality of predicates within the respective semantic parsing examples; and
determining, utilizing the data clustering model, the clusters of semantic parsing examples based on comparing the respective feature vectors.

5. The computer-implemented method of claim 1, further comprising:
generating, utilizing an additional target semantic parsing model, additional predicted structural representations of the natural language queries of the set of semantic parsing examples; and
determining additional respective correctness values for the clusters of semantic parsing examples based on comparing the additional predicted structural representations and the corresponding structural representations of the set of semantic parsing examples.

6. The computer-implemented method of claim 5, further comprising selecting the target semantic parsing model or the additional target semantic parsing model based on a comparison between the respective correctness values and the additional respective correctness values for the clusters of semantic parsing examples.

7. The computer-implemented method of claim 1, further comprising:
receiving an input natural language query requesting generation of a structural representation;
determining, utilizing the natural language processing model, one or more predicates corresponding to the input natural language query; and
generating, utilizing a correctness estimation model, a predicted correctness value indicating a likelihood that the target semantic parsing model will generate an accurate structural representation from the input natural language query.

8. The computer-implemented method of claim 7, further comprising providing, in response to determining that the predicted correctness value generated for the input natural language query falls below a predetermined threshold value, at least one suggestion to modify the input natural language query based on at least one predicate of the one or more predicates corresponding to the input natural language query.

9. The computer-implemented method of claim 7, further comprising utilizing the natural language processing model to modify, in response to determining that the predicted correctness value generated for the input natural language query falls below a predetermined threshold value, the input natural language query with respect to at least one predicate of the one or more predicates corresponding to the input natural language query.

10. The computer-implemented method of claim 1, further comprising modifying, in response to determining that a correctness value of the respective correctness values corresponding to a particular cluster of the clusters of semantic parsing examples falls below a predetermined threshold value, one or more parameters of the target semantic parsing model to reduce an error between the predicted structural representations and the corresponding structural representations associated with the particular cluster.

11. The computer-implemented method of claim 1, further comprising generating, in response to determining that a correctness value of the respective correctness values corresponding to a particular cluster of the clusters of semantic parsing examples falls below a predetermined threshold value, at least one adversarial training example comprising (i) an example natural language query including at least one predicate associated with the particular cluster and (ii) a ground truth structural representation corresponding to the example natural language query.

12. A system comprising:
one or more memory devices; and
one or more processors configured to cause the system to:
generate, utilizing a natural language processing model, textual descriptions of a set of semantic parsing examples comprising natural language queries and corresponding structural representations;
extract, from the textual descriptions, a plurality of predicates for the set of semantic parsing examples;
determine, utilizing a data clustering model, clusters of semantic parsing examples according to similarities between respective predicates of the plurality of predicates;
generate, utilizing a target semantic parsing model, predicted structural representations of the natural language queries of the set of semantic parsing examples; and
determine respective correctness values for the clusters of semantic parsing examples based on comparing the predicted structural representations and the corresponding structural representations of the set of semantic parsing examples.

13. The system of claim 12, wherein the one or more processors are further configured to cause the system to extract the plurality of predicates for the set of semantic parsing examples by utilizing the natural language processing model to determine binary logical expressions from the textual descriptions of the set of semantic parsing examples.

14. The system of claim 13, wherein the one or more processors are further configured to cause the system to:
generate, for respective semantic parsing examples of the set of semantic parsing examples, respective feature vectors indicating a presence or absence of each predicate of the plurality of predicates within the respective semantic parsing examples; and
determine, utilizing the data clustering model, the clusters of semantic parsing examples based on comparing the respective feature vectors.

15. The system of claim 12, wherein the one or more processors are further configured to cause the system to generate the textual descriptions of the set of semantic parsing examples by utilizing the natural language processing model to process the natural language queries, the corresponding structural representations, and a structural schema of the corresponding structural representations.

16. The system of claim 15, wherein the structural schema of the corresponding structural representations comprises one or more of an indication of a domain-specific language, a structural description of a target database, or a template structural representation.

17. A non-transitory computer readable medium storing executable instructions which, when executed by a processing device, cause the processing device to perform operations comprising:
receiving an input natural language query requesting generation of a structural representation;
extracting, utilizing a natural language processing model, predicates corresponding to the input natural language query;
generating, utilizing a correctness estimation model, a predicted correctness value indicating a likelihood that a given semantic parsing model will generate an accurate structural representation from the input natural language query; and
generating, in response to determining that the predicted correctness value falls below a predetermined threshold value, an adjusted natural language query comprising at least one modification based on at least one predicate of the predicates extracted from the input natural language query.

18. The non-transitory computer readable medium of claim 17, wherein generating the adjusted natural language query comprises:
providing, to a user via a client device, at least one suggestion to modify the input natural language query based on the at least one predicate of the predicates corresponding to the input natural language query; and
receiving, via the client device, the adjusted natural language query.

19. The non-transitory computer readable medium of claim 17, wherein generating the adjusted natural language query comprises utilizing a natural language processing model to modify the input natural language query with respect to the at least one predicate of the predicates corresponding to the input natural language query.

20. The non-transitory computer readable medium of claim 17, the operations further comprising:
determining, utilizing the correctness estimation model and based on the predicates corresponding to the input natural language query, an additional predicted correctness value corresponding to an alternative semantic parsing model; and
providing, in response to determining that the additional predicted correctness value is greater than the predicted correctness value for the given semantic parsing model, a suggestion to utilize the alternative semantic parsing model to generate a structural representation for the input natural language query.
